(19) United States
(12) Patent Application Publication
(10) Pub. No.: US 2004/0110565 A1
(43) Pub. Date: Jun. 10, 2004

(54) Mobile electronic video game

(76) Inventor: Louis Levesque, Canton de Granby (CA)

Correspondence Address: BOMBARDIER RECREATIONAL PRODUCTS, LEGAL SERVICES - ST-BRUNO, PO BOX 230, NORTON, VT, 05907-0230, US

(21) Appl. No.: 10/726,572

(22) Filed: Dec. 4, 2003

Related U.S. Application Data
(60) Provisional application No. 60/430,682, filed on Dec. 4, 2002.

(51) Int. Cl. A63F 9/24; A63F 13/00

(52) U.S. Cl. 463/42; 463/36

(57) ABSTRACT

A video gaming device includes a central gaming unit in communication with a heads-up display and a location sensing sensor. The location sensor is preferably in the form of a global positioning system satellite receiver, and senses the video gaming device's geographic location. Ideally, the video gaming device is used in conjunction with a vehicle, such as a recreational vehicle in the form of a snowmobile, all terrain vehicle or personal watercraft. Game play is controlled by interaction with the vehicle, thus combining the enjoyment derived from operation of the vehicle with enjoyment derived from the game. Optionally, a plurality of sensors and interfaces sense the operating condition of the vehicle, and reaction of the user. Various games may be loaded into the device from a computer readable medium storing gaming software.

The present application claims priority to U.S. Provisional Application of Levesque, Serial No. 60/430,682, filed Dec. 4, 2002, the entirety of which is hereby incorporated into the present application by reference.

### FIELD OF THE INVENTION

The present invention relates to video games, and more particularly to mobile electronic video games.

### BACKGROUND OF THE INVENTION

Since their advent in the 1970s, electronic video games have captured the imaginations of millions. Although these games were initially limited to crude graphics displayed on cathode ray tubes, the continuous improvement in computing and display technology has allowed for the never-ending improvement of video and the video gaming experience.

In the last decade virtual reality games have been developed. These games allow players to experience simulated realities. They display game images in three dimensions, and allow player interaction with the presented reality using a variety of sensors. For the most part, these games simulate only limited game scenarios. None have yet simulated an entire virtual world. Interestingly, none of these games has gained widespread commercial success.

In part, the lack of commercial success of existing virtual reality games may be attributable to the current state of technology and the quality of the games. However, it is also attributable to the relatively small consumer market; the appeal of these games is limited to devoted video gamers.

Some games have attempted to incorporate additional activities with the video gaming experience. For example, some video games attempt to incorporate sports and exercise with the video gaming experience. One such game allows a stationary bicycle rider to be part of a simulated race. These games, however, have served more as a motivational tool than as a form of entertainment. Further, the sports and exercise activity is often constrained to accommodate use of the video game.

Accordingly, there is a need for an improved video game that interacts with other forms of amusement, preferably presenting some form of simulated reality.

### SUMMARY OF THE INVENTION

In accordance with an aspect of the present invention, a video gaming device includes a central gaming unit in communication with a heads-up display and a location sensing sensor. The location sensor is preferably in the form of a global positioning system satellite receiver, and senses the video gaming device's geographic location. Ideally, the video gaming device is used in conjunction with a vehicle, such as a recreational vehicle in the form of a snowmobile, all terrain vehicle or personal watercraft. Game play is controlled by interaction with the vehicle, thus combining the enjoyment derived from operation of the vehicle with enjoyment derived from the game. Optionally, a plurality of sensors and interfaces sense the operating condition of the vehicle, and reaction of the user.

In accordance with another aspect of the present invention, an electronic video gaming device, including: a processor in communication with processor readable memory; a video interface; a heads-up display; a location sensor for sensing a geographic location of the device, the location sensor in communication with the processor to provide data indicative of the geographic location to the processor; and a vehicle engine interface, for interconnection to an engine of a vehicle to sense a plurality of operating parameters of the engine. The memory stores gaming software, to present a video game on the heads-up display, wherein play of the video game is controlled by the data from the location sensor.

In accordance with a further aspect of the present invention, a computer readable medium, storing gaming software loadable at a gaming device, the gaming device including a processor in communication with processor readable memory; a video interface, in communication with a heads-up display; and a location sensor for sensing a geographic location of the gaming device, in communication with the processor. The gaming software adapts the gaming device to present a video game whose play is controlled by location of the gaming device, as sensed by the location sensor.

In accordance with yet a further aspect of the present invention, a method of operating an electronic video gaming device in a moving vehicle, the method including: presenting a video game on a heads-up display; sensing a geographic location of the video gaming device; controlling play of the video game based on the sensed geographic location.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate by way of example only, embodiments of this invention:

FIG. 1 is a simplified block diagram of a video gaming device exemplary of an embodiment of the present invention;

FIG. 2 is a block diagram of a central gaming unit of the device of FIG. 1;

FIG. 3 is a perspective view of a recreational vehicle including a video gaming device exemplary of an embodiment of the present invention; and

FIGS. 4-8 are screens captures illustrating exemplary video game play using the device of FIG. 1.

### DETAILED DESCRIPTION

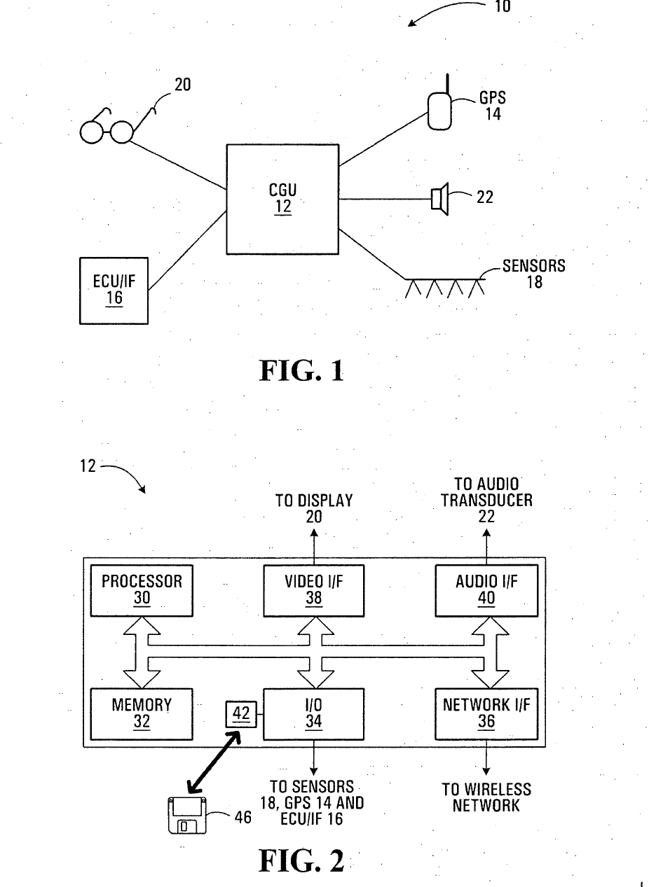

FIG. 1 illustrates a mobile electronic video gaming device 10 exemplary of an embodiment of the present invention. As illustrated, exemplary mobile gaming device 10 includes a central electronic gaming unit 12 interconnected with a location sensor 14; a vehicle electronic control unit interface (ECU/IF) 16; a plurality of sensors 18; a heads-up display 20; and an audio output transducer 22.

A preferred simplified example architecture for central gaming unit 12 is illustrated in FIG. 2. As illustrated, gaming unit 12 has an architecture very similar to that of a conventional computing device. As such, gaming unit 12 includes a central processor 30 in communication with memory 32, a video interface 38, an audio interface 40, an input/output interface 34 and optionally a network interface 36. Gaming device 10 further includes a memory reader 42. Memory reader 42 may be a CD-ROM, DVD, diskette or similar drive, ROM slot, or the like for loading gaming software for processing by device 10 from a computer readable medium 46. Computer readable medium 46, in turn may be an optical storage memory such as a CD-ROM, DVD or the like; magnetic memory in the form of a diskette or the like; or a solid state memory such as a ROM cartridge.

Processor 30 may be any suitable processor capable of processing processor executable instruction of sufficient complexity and at sufficient speed to present a near real-time gaming environment to an end-user. Processor 30 may for example be a conventional x86 processor, a RISC processor, or any other processor known to those of ordinary skill. Memory 32 may be any combination of computer readable memory and may include persistent storage memory in the form of a hard disk drive, random access memory, static memory, and the like. Video interface 38 preferably includes a video processor capable of displaying three-dimensional graphics at suitable resolutions and speeds to present a game-playing environment, or to represent images that may be superimposed on a background representing a real-world environment. Video interface 38 preferably includes a port for connection to a suitable heads-up display 20 (FIG. 1).

Audio interface 40 receives audio data from processor 30 or memory 32 and produces corresponding analog audio effects in the form of music, sound effects and the like on audio transducer 22 (FIG. 1).

Optionally, central gaming unit 12 includes a network interface 36 for interconnection with a wireless communications network. Network interface 36 for example may allow gaming unit to communicate by way of a wireless GPRS, CDMA or other network. As will become apparent, network interface 36 may allow communication of gaming unit 12 with a server or other similar proximate central gaming units, either by way of data or voice.

Input/output interface 34 preferably includes suitable ports for connection of sensors 18, location sensor 14, and ECU interface 16. Input/output interface 34 may for example be a high-speed parallel or serial port and may for example include one or more optical, electrical or wireless ports.

Heads-up display 20 is preferably a video display device that allows an operator to view an image without diverting his or her eyes from their normal point of focus. Preferably, computer generated images displayed by way of display 20 are overlayed on a user's view of the real world. Heads-up display 20 for example may include an automobile or other vehicle windshield and associated projector for projecting an image thereon. Heads-up display 20 may alternatively take the form of monocular or binocular viewers that may, for example, be in the form of integrated eye glasses, again allowing the user to view an electronically presented image without unduly obstructing the user's view. As another further alternative, heads-up display 20 may form part of a helmet visor. Optionally, multiple independent heads-up displays could be connected to video interface 38. In this way, two or more users could jointly participate in game play using device 10. Existing heads-up displays suitable for use as heads-up display 20 are well known in the art. For example MicroOptical Corporation manufactures a suitable heads-up display, available in association with the trademark Video Viewer. The development of a multitude of other heads-up displays suitable for use as part of gaming device 10, are anticipated.

Location sensor 14 is preferably a conventional global positioning system (GPS) satellite receiver that provides an indication of sensed geographic location to gaming unit 12 via suitable port that may for example form part of input/output interface 34. Typically data indicative of sensed latitude, longitude, and optionally altitude (or elevation) is provided to central gaming unit 12. Changes in sensed location over time may be used to assess velocity of gaming unit 12. GPS receivers as so described are also readily available and understood. For example, Motorola's Instant GPS, SiGe Semiconductor's SE1400 GPS IC or RF Micro Devices' RF8000 could be used in suitable GPS receivers.

External sensors 18 include a plurality of sensors suitable for sensing external physical operating parameters. Sensors 18 may, for example, include a plurality of tracking sensors worn by a user, providing indicators of movements of certain of the user's body parts. Example sensors 18 could include glove based sensors; exoskeleton devices; electromechanical sensors (e.g. microelectromechanical system (MEMS) sensors); optical sensors; retinal sensors; acoustical sensors; or the like. In a preferred embodiment, example sensors 18 include a sensor indicative of the position or movement of a user's limbs relative to his or her body, and sensors to sense the position (e.g. tilt and rotation) of the user's head relative to the user's torso. Sensors 18 further preferably include one or more button or trigger sensors, connected to suitable buttons/triggers allowing a user to provide deliberate control inputs. Suitable electromechanical sensors may be installed in gear, such as a helmet, face mask, suit or gloves worn by the user or on ancillary equipment used in association with gaming device 10. Sensors can additionally sense water conditions (e.g. chop); weather conditions (temperature, humidity, etc.); vehicle state including steering position, throttle position and transmission position. Countless other sensors could be included as required. These tracking sensors provide a suitable electronic sensing signal, in analog or digital form, to central gaming unit 12 by way of, for example, input/output interface 34. Ultimately, numerical values indicative of the sensors states may be used by central gaming unit 12. As will become apparent, these numerical values are used to control game play.

ECU interface 16 allows determination of the operating parameters of a vehicle by sensing engine-operating conditions and providing these to central gaming unit 12. ECU interface 16 includes suitable electronics for connecting gaming unit 12 to the electronic control unit of an associated vehicle engine. As such, interface 16 allows both the sensing and control of vehicle engine parameters such as throttle, operating speed, and engine temperature. ECU interface 16 preferably includes one or more output ports to provide controlled outputs to limit one or more of these operating parameters including for example, engine speed and throttle and kill (i.e. shut off) the engine.

Central gaming unit 12 is further preloaded with video game software read from computer readable medium 46, exemplary of embodiments of the present invention. Persons of ordinary skill will readily appreciate that the creation of video game software is well understood. For example, game development kits on a variety of platforms exist. For reasons that will become apparent, virtual reality modeling software, might be used to form suitable gaming software. Alternatively, such gaming software may be written on a general-purpose central gaming unit 12 using techniques understood by those of ordinary skill. Unlike conventional gaming software however, gaming software exemplary of the embodiments of the present invention processes inputs taken from one or more of location sensor 14, external sensors 18 and ECU interface 16, as described below.

Audio output transducer 22 generates audible sounds in response to electronic signals provided to it. Audio transducer 22 may be a speaker, piezoelectric element, earphone, or the like. Audio transducer 22 generates sounds in the form of music from signals provided by audio interface 40.

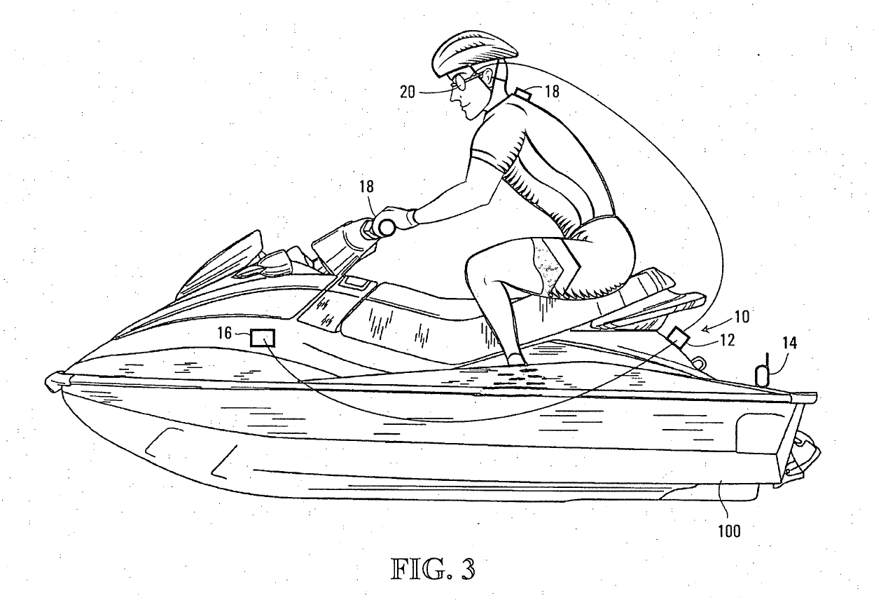

In operation, mobile video gaming device 10 is preferably fitted on a vehicle. Preferably mobile video gaming device 10 is fitted on a recreational vehicle such as a snowmobile, all-terrain vehicle or personal watercraft. Example vehicles include a Bombardier® Ski-Doo® Rev™ snowmobile; a Bombardier™ DS650™ all-terrain vehicle; or a Bombardier® Sea-Doo® XP® personal watercraft. FIG. 3 accordingly illustrates a vehicle 100 in the form of a personal watercraft equipped with a game device 10, of the type depicted in FIGS. 1 and 2. A user/operator and several sensors 18 are also illustrated.

Display 20 is configured so that a user/operator and/or passenger of the vehicle is presented with a heads-up display allowing the operator or passenger to view the path of the vehicle while viewing an image presented by mobile gaming device 10.

After initial configuration a game user is presented with a conventional startup/option screen for a video game. Inputs controlling play of the video game, however, are provided at least in part by actual operation of the vehicle through sensors 18, location sensor 14, and ECU interface 16.

In this way gaming device 10 may be aware of the current location and speed of the associated vehicle 100 as provided by location sensor 14; certain physical parameters provided by sensors 18; and the operating condition of the vehicle's engine as provided by ECU interface 16. With these inputs, any variety of games may be defined.

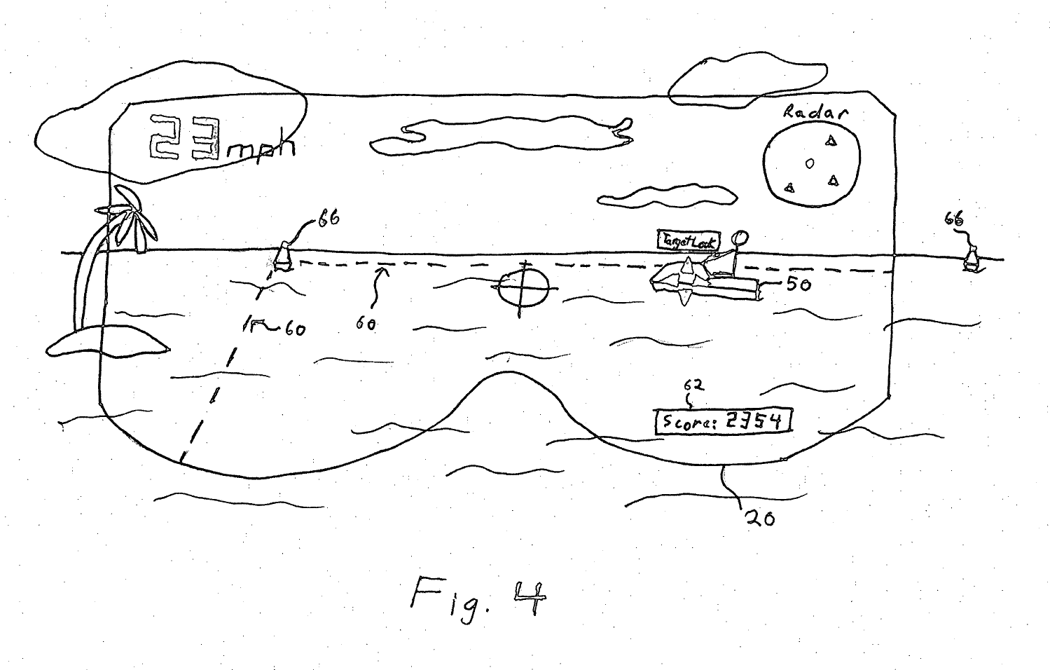

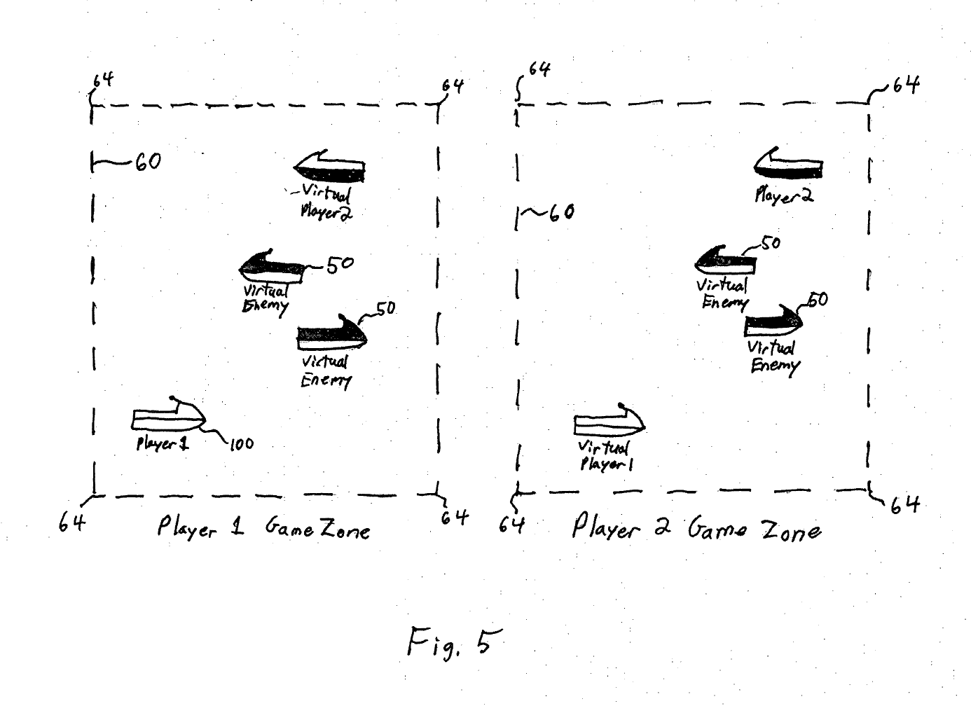

FIGS. 4 to 8 therefore illustrate example games that may be presented by gaming device 10 to an operator. As illustrated in FIG. 4, a first example game may present simulated opponents 50 within a virtual boundary 60. Images of craft(s) representing the opponents 50 are presented to the user on display 20. Inputs received by way of external sensors 18 and location sensor 14 allows gaming device 10 to simulate interaction with these virtual opponents 50. For example, as the opponents 50 are approached, their size may be magnified on display 20, much in the same way a user would view actual opponents. Any motion of the user's head, as sensed by one of external sensors 18 may be taken into account. To enhance game play, movement of the enemies in three-dimensional space, within defined boundaries may be simulated. The position and speed of the vehicle 100 may be taken into account when presenting the simulated images on display 20. Sensor inputs may allow the deployment of simulated weapons to destroy the virtual opponents 50. Scores 62 may be accumulated and tracked by gaming unit 12 as each opponent 50 is destroyed. Optionally, weapon fire from opponents 50 may be simulated on display 20. Actual motion of the vehicle to avoid launched weapons may also be accounted for. Inputs received from location sensor 14 may be used to assess the vehicle's relative position to any virtual opponents 50 as well as vehicle speed and the like.

Further, as illustrated in FIG. 5 a virtual boundary 60 may be enforced by gaming device 10, to ensure safe game play. The virtual boundary 60 may initially be defined by way of a configuration screen similar to that illustrated in FIG. 5. The configuration screen may allow a user to travel to the corners 64 of the boundary using vehicle 100 and providing an input by way of one of sensors 18, for example in the form of a button on the player's uniform or on vehicle 100. The location of the boundary 60 may be stored within memory 32 for later use. Preferably the boundary region is rectangular in nature, thereby requiring only inputs of opposed corners 64. Once the boundary 60 is defined and stored at central gaming unit 12, gaming unit 12 may react to an operator crossing the defined virtual boundary 60 (as sensed through location sensor 14) with the vehicle by disabling or slowing the vehicle's engine through ECU interface 16 or alternatively sending a necessary warning to the operator by way of display 20 to shut down the vehicle and/or disable the game, thereby maintaining a level of safety.

Similarly, gaming device 10 may monitor the overall speed of the vehicle (by way of location sensor 14), send warnings by way of display 20 and audio transducer 22 and slow the vehicle through ECU interface 16 in the event that speed thresholds are exceeded. Again speed thresholds could be set by a gaming unit operator and could, for example, be password protected or through a key, such as the Sea-Doo® Learning Key™, available for certain Bombardier Recreational Products recreational vehicles.

Optionally, multiple vehicles each equipped with gaming device 10 could be allowed to play within one set of virtual boundaries 60. As a further alternative, information about multiple players each playing within his/her own non-overlapping virtual boundaries 60 may be assimilated. Information about the players may be shared between multiple gaming devices 10 (as for example by way of network interface 36) and each gaming device 10 may superimpose the multiple game zones, and present images representing players outside a current player's zone in that player's heads up display. In this way, the multiple players may play against each other without occupying the same physical space. Again, to facilitate play between multiple players, voice data may be exchanged between players by way of network interface 36, or otherwise.

As a further option, visible buoys 66 (see FIG. 4) delineating the virtual boundaries 60 may be placed at the corners 64 of the virtual boundaries 60. The buoys 66 may be simple floating buoys. Optionally, they may be equipped with one or more transmitters to dispatch a signal for receipt by gaming devices 10 (again, possibly by way of network interface 36) within a delineated virtual boundary 60. Multiple buoys 66 may be physically connected to each other, by way of a rope or string, or the like. Breach (i.e. trespass into, or escape from) of a virtual boundary 60n could be detected as a result of disconnection of the rope or string. This breech could be signalled to gaming devices 10 to again slow or stop the vehicles. Advantageously, breach of the virtual boundary 60 by persons other than game participants may thus be detected.

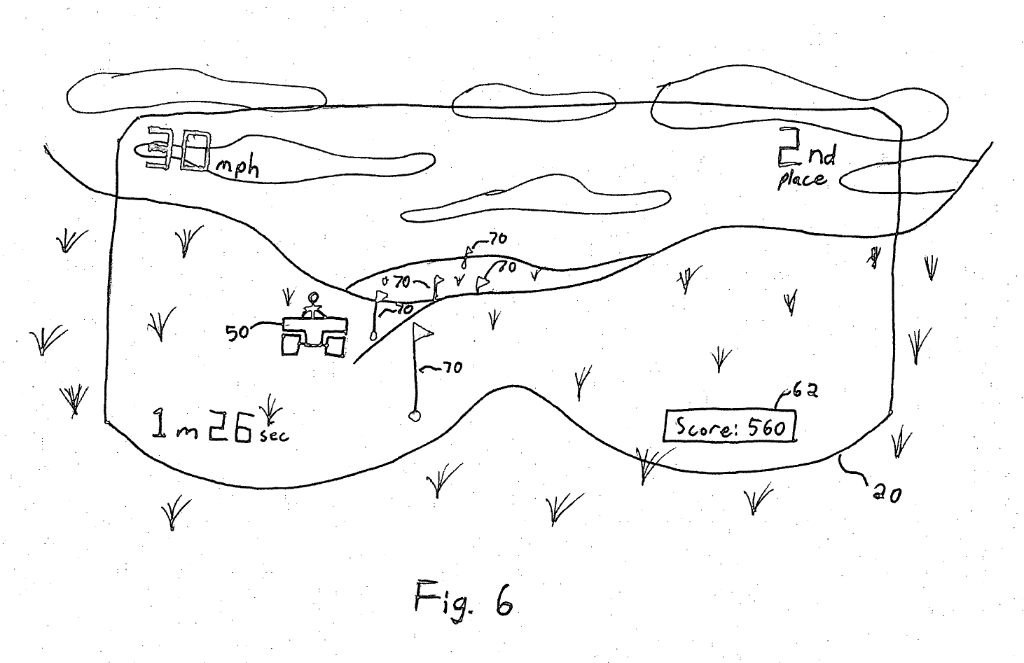

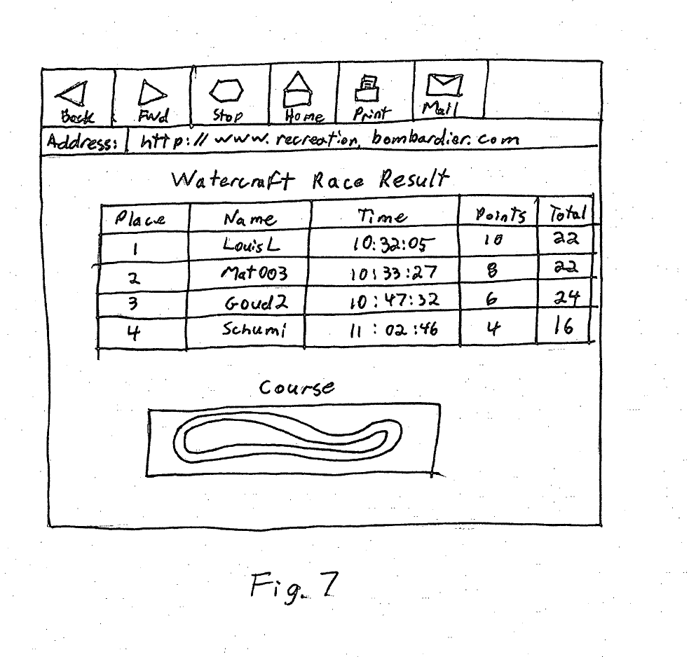

A further alternative game is illustrated with reference to FIG. 6. As illustrated, a virtual obstacle course in three dimensions may be presented on display 20 as illustrated in FIG. 6. An operator of the vehicle may steer the vehicle to avoid collision with the presented obstacles 70. Again, gaming device 10 simulates the obstacles 70 on display 20 and assess the location and operating speed of the vehicle relative to the simulated obstacles 70 thereby allowing the simulation of interaction of the player with the course. Conveniently, scores 62 of multiple players (each playing within a separately defined and enforced boundary) may be maintained by gaming device 10 or alternatively communicated wirelessly by way of network interface 34 (FIG. 2) to other gaming units or to a centralized network site. An example score board is illustrated in FIG. 7.

As should now be appreciated, use of sensors 14, 18 and ECU interface 16 allows for a wide variety of simulated games for use with a vehicle. The game may, for example, be simulated with reference to a map based on known geography of an area. Data representative of maps in known usage areas may be stored on computer readable medium 46 or otherwise in memory 32. Map information may be correlated to measured location as sensed by location sensor 14. Obstacles 70 in the form of islands, houses, and the like may be presented on heads-up display 20 with reference to knowledge of the existing topography. Similarly treasures, enemies 50, targets, other players and the like may be simulated (and thus for example, hidden or blended) with the existing natural backdrop seen through heads-up display 20, with reference to the existing topography.

In a further embodiment, gaming device 10 may use information about the geography to present targets and obstacles as a realistic backdrop to the remaining scenery. This may for example be useful in an automobile. Gaming device 10 may present an image such as a target, deer, an opponent, etc. apparent on the side of the road. Capture, stunning or killing of the target may be assessed using telemetry sensors or other interfaces. Again, an optional one of sensors 18 may take the form of a simulated pistol, rifle or the like.

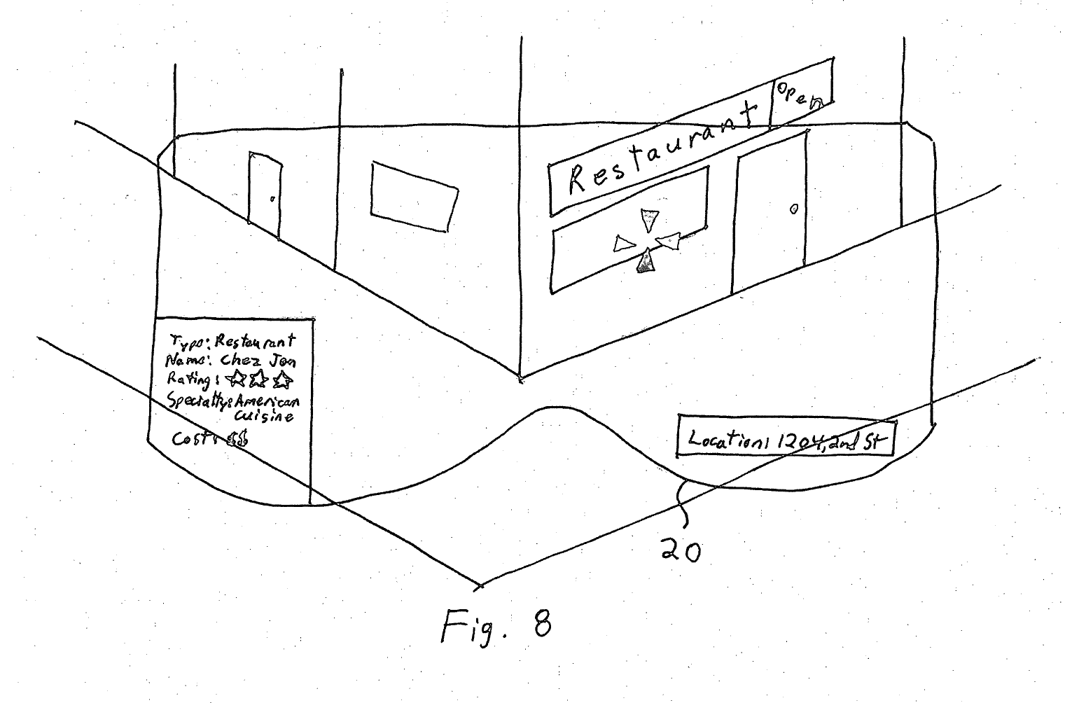

As a further option, gaming device 10 may serve as a virtual guide, providing heads-up information about scenic areas, buildings and the like as illustrated in FIG. 8. Again, data about scenery, visual through heads-up display 20 may be obtained using knowledge of the gaming device's location (as determined by location sensor 14) as well as the user's line of sight (as determined through sensors 18). Historical facts, trivia, advertisements, and the like could be presented based on the knowledge of location and line of sight. Computer readable media (such as medium 46) may be made available for multiple possible areas of interest. As required, additional data could be obtained by device 10 over a data network by way of network interface 36 (FIG. 2).

From the forgoing it should be readily appreciated that nearly an infinite variety of gaming software taking advantage of one or more of display 20, location sensor 14 and sensors 18 may be possible. Each game may be loaded from a computer readable medium, like medium 46. New games may be periodically provided. As required, additional sensors may be added to device 10. Advantageously, enjoyment provided by vehicle 100 may be combined with the provided video games for an enhanced use and enjoyment.

Of course, the above-described embodiments are intended to be illustrative only and in no way limiting. The described embodiments of carrying out the invention are susceptible to many modifications of form, arrangement of parts, details and order of operation. The invention, rather, is intended to encompass all such modification within its scope, as defined by the claims.

What is claimed is:

1. An electronic video gaming device, comprising:
a processor in communication with processor readable memory;
a video interface;
a heads-up display;
a location sensor for sensing a geographic location of said device, said location sensor in communication with said processor to provide data indicative of said geographic location to said processor;
said processor readable memory storing gaming software, to present a video game on said heads-up display, wherein play of said video game is at least partially controlled by said data from said location sensor.

2. The gaming device of claim 1, further comprising:
a plurality of sensors, in communication with said processor, each of said sensors for sensing an external input used to influence play of said video game.

3. The gaming device of claim 2, wherein at least one of said sensors is wearable and senses a position of a user's head.

4. The gaming device of claim 3, wherein said location sensor comprises a global positioning system (“GPS”) satellite receiver.

5. The gaming device of claim 1, further comprising:
a vehicle engine interface for interconnecting a vehicle engine with said processor in order to provide data on at least one engine operating parameter to said processor.

6. The gaming device of claim 5, wherein said vehicle engine interface is further capable of providing said engine with data from said processor to control engine operation.

7. The gaming device of claim 6, wherein said engine will turn off in response to data received from said processor.

8. The gaming device of claim 6, wherein an operating speed of said engine is limited in response to data received from said processor.

9. The gaming device of claim 4, wherein said heads-up display forms part of a helmet.

10. The gaming device of claim 7, wherein said gaming software limits operation of an interconnected vehicle, when said device's position is outside a pre-defined boundary.

11. The gaming device of claim 10, wherein said software limits operation of an interconnected vehicle, when another vehicle breaches said pre-defined boundary.

12. The gaming device of claim 1, wherein said video game presents an obstacle course to be navigated by moving said gaming device.

13. The gaming device of claim 2, wherein said sensors sense at least one of water conditions, weather conditions, vehicle steering position, vehicle throttle position and vehicle transmission position.

14. A recreational vehicle comprising an electronic video gaming device as claimed in claim 1.

15. The gaming device of claim 1, wherein said heads-up display overlays computer generated images on a surrounding environment.

16. Computer readable medium, storing gaming software loadable at a gaming device, said gaming device comprising a processor in communication with processor readable memory; a video interface, in communication with a heads-up display; and a location sensor for sensing a geographic location of said gaming device, in communication with said processor; said gaming software adapting said gaming device to present a video game on said heads-up display whose play is at least partially controlled by location of said gaming device, as sensed by said location sensor.

17. A method of operating an electronic video gaming device in a moving vehicle, said method comprising:
presenting a video game on a heads-up display;
sensing a geographic location of said video gaming device;
at least partially controlling play of said video game based on said sensed geographic location.

18. The method of claim 17, further comprising:
limiting operation of an engine of said vehicle, when said sensed geographic location is outside a pre-defined boundary.

19. The method of claim 17, further comprising:
presenting elements of said video game according to topographical information.

20. The method of claim 17, further comprising:
clearing said heads-up display, when said said sensed geographic location is outside a predefined boundary.

21. The method of claim 17, further comprising:
defining a game zone; and
presenting at least one other vehicle on said heads-up display,
wherein a position within said game zone on said heads-up display of said other vehicle corresponds to an actual position of said other vehicle within another game zone.

22. The method of claim 17, further comprising:
controlling play of said video game based on at least one of vehicle steering position, vehicle throttle position, vehicle transmission position and user's head position.
